(19) United States
(12) Patent Application Publication
(10) Pub. No.: US 2026/0074459 A1
(43) Pub. Date: Mar. 12, 2026

(54) ELECTRICAL CONNECTOR AND CONNECTOR ASSEMBLY WITH REINFORCING WALL

(71) Applicant: DONGGUAN LUXSHARE TECHNOLOGIES CO., LTD, Dongguan City (CN)

(72) Inventors: Ludong LI, Dongguan City (CN); Sihai YI, Dongguan City (CN); Zhaolong ZENG, Dongguan City (CN); Kaide WANG, Dongguan City (CN)

(73) Assignee: DONGGUAN LUXSHARE TECHNOLOGIES CO., LTD, Dongguan City (CN)

(21) Appl. No.: 18/896,218

(22) Filed: Sep. 25, 2024

(30) Foreign Application Priority Data
Sep. 6, 2024 (CN) 202422194029.X

(51) Int. Cl. H01R 13/506; H01R 13/629

(52) U.S. Cl. CPC H01R 13/506; H01R 13/629

(57) ABSTRACT

An electrical connector includes an insulating body, a tongue plate and a locking elastic piece. The locking elastic piece includes a first locking portion, a second locking portion and a connecting wall. The first locking portion includes a first locking protrusion. The second locking portion includes a second locking protrusion. The connecting wall is configured to drive the first locking portion and the second locking portion to elastically deform under an action of an external force, so that the first locking protrusion and the second locking protrusion are separated from a first locking hole and a second locking hole of a mating connector. The locking elastic piece further includes a reinforcing wall that at least partially overlaps the connecting wall to increase the rigidity of the connecting wall. A connector assembly having the electrical connector is also disclosed.

### CROSS-REFERENCE TO RELATED APPLICATION

This patent application claims priority of a Chinese Patent Application No. 202422194029.X, filed on Sep. 6, 2024 and titled “ELECTRICAL CONNECTOR AND CONNECTOR ASSEMBLY”, the entire content of which is incorporated herein by reference.

### TECHNICAL FIELD

The present disclosure relates to an electrical connector and a connector assembly, which belong to the technical field of connectors.

### BACKGROUND

A connector assembly in the related art generally includes a plug connector and a receptacle connector for mating with each other. The receptacle connector includes a receptacle insulating body, a plurality of receptacle conductive terminals mounted to the receptacle insulating body, and a metal shell covering a periphery of the receptacle insulating body. The metal shell defines a first locking hole and a second locking hole.

The plug connector usually includes a plug insulating body, a tongue plate, a locking elastic piece and a pull strap. The tongue plate is provided with a plurality of conductive pads. The conductive pads are in contact with the receptacle conductive terminals. The locking elastic piece usually includes a first locking protrusion, a second locking protrusion and a connecting rod. The first locking protrusion and the second locking protrusion are used to mate with the first locking hole and the second locking hole, respectively. The connecting rod is connected to the pull strap to apply an external force thereto. The external force is able to drive the first locking protrusion and the second locking protrusion to move, thereby achieving unlocking.

However, the connecting rod in the related art is similar to a cross beam and is connected between the first locking protrusion and the second locking protrusion. When the external force acts on the connecting rod through the pull strap, the connecting rod itself is prone to elastic deformation because the length of the connecting rod is usually long. It is understandable to those skilled in the art that whether the unlocking can be successful depends on whether the first locking protrusion and the second locking protrusion can be separated from the first locking hole and the second locking hole, driven by the connecting rod. With the development trend of connector miniaturization, the space left on the plug connector for the locking elastic piece to deform to achieve unlocking has become smaller and smaller. However, the elastic deformation of the connecting rod itself will also offset part of the unlocking space, thus easily leading to unlocking failure.

Therefore, it is desirable to improve the connector assembly in the related art.

### SUMMARY

An object of the present disclosure is to provide an electrical connector and a connector assembly with improved unlocking reliability.

In order to achieve the above object, the present disclosure adopts the following technical solution: an electrical connector, including: an insulating body, the insulating body defining a first installation groove and a second installation groove; a tongue plate, the tongue plate being fixed to the insulating body, the tongue plate including a plurality of conductive pads provided on at least one surface thereof; and a locking elastic piece, the locking elastic piece including a first lock portion, a second lock portion and a connecting wall connecting the first locking portion and the second locking portion; the first locking portion being at least partially installed in the first installation groove; the second locking portion being at least partially installed in the second installation groove; the first locking portion including a first locking protrusion; the second locking portion including a second locking protrusion; the first locking protrusion and the second locking protrusion being configured to mate with a first locking hole and a second locking hole of a mating connector, respectively; the connecting wall being configured to drive the first locking portion and the second locking portion to elastically deform under an action of an external force, so that the first locking protrusion and the second locking protrusion are separated from the first locking hole and the second locking hole of the mating connector; wherein the locking elastic piece further includes a reinforcing wall that at least partially overlaps the connecting wall to increase rigidity of the connecting wall; the connecting wall and the reinforcing wall form a double-layer structure.

In order to achieve the above object, the present disclosure adopts the following technical solution: a connector assembly, including: an electrical connector, the electrical connector including: an insulating body, the insulating body defining a first installation groove and a second installation groove; a tongue plate, the tongue plate being fixed to the insulating body, the tongue plate including a plurality of conductive pads provided on at least one surface thereof; and a locking elastic piece, the locking elastic piece including a first lock portion, a second lock portion and a connecting wall connecting the first locking portion and the second locking portion; the first locking portion being at least partially fixed in the first installation groove; the second locking portion being at least partially fixed in the second installation groove; the first locking portion including a first locking protrusion; the second locking portion including a second locking protrusion; wherein the locking elastic piece further includes a reinforcing wall that at least partially overlaps the connecting wall to increase rigidity of the connecting wall; the connecting wall and the reinforcing wall form a double-layer structure; and a mating connector, the mating connector including a mating insulating body, a plurality of mating conductive terminals mounted to the mating insulating body, and an outer shell fixed to the mating insulating body; the mating insulating body including a mating slot; the outer shell defining a first locking hole and a second locking hole; when the electrical connector is mated with the mating connector, the tongue plate is at least partially inserted into the mating slot; the conductive pads on the tongue plate are in contact with the mating conductive terminals; the first locking protrusion and the second locking protrusion of the electrical connector are locked in the first locking hole and the second locking hole of the mating connector, respectively; when unlocking is required, the connecting wall drives the first lock portion and the second lock portion to elastically deform under an action of an external force, so that the first locking protrusion and the second locking protrusion are separated from the first locking hole and the second locking hole of the mating connector.

Compared with the prior art, the locking elastic piece of the electrical connector of the present disclosure is provided with the reinforcing wall that at least partially overlaps the connecting wall to increase the rigidity of the connecting wall. The connecting wall and the reinforcing wall form the double-layer structure which increases the rigidity of the connecting wall and reduces the risk of elastic deformation of the connecting wall itself. As a result, the reliability of the connecting wall in driving the first locking portion and the second locking portion to elastically deform is improved, thereby improving the unlocking reliability when the electrical connector and the mating connector need to be separated.

### BRIEF DESCRIPTION OF DRAWINGS

FIG. 1 is a perspective view of a connector assembly in accordance with an embodiment of the present disclosure, in which an electrical connector and a mating connector are in a locked state;

FIG. 2 is a front view of FIG. 1;

FIG. 3 is a partially exploded perspective view of FIG. 1, in which the electrical connector and the mating connector are in an unlocked and separated state;

FIG. 4 is a top view of the mating connector shown in FIG. 3;

FIG. 5 is a front view of the mating connector shown in FIG. 3;

FIG. 6 is a front view of the electrical connector shown in FIG. 3;

FIG. 7 is a top view of the electrical connector shown in FIG. 3;

FIG. 8 is a partially exploded perspective view of the mating connector shown in FIG. 3;

FIG. 9 is a partially exploded perspective view of FIG. 8 from another angle;

FIG. 10 is a partial perspective exploded view of a first mating terminal module, a second mating terminal module, a third mating terminal module and a power terminal module in FIG. 8;

FIG. 11 is a partially exploded perspective view of the electrical connector in FIG. 3, in which a locking elastic piece and a pull strap are separated;

FIG. 12 is a partially exploded perspective view of FIG. 11 from another angle;

FIG. 13 is a further partially exploded perspective view of FIG. 11;

FIG. 14 is a partially exploded perspective view of FIG. 13 from another angle;

FIG. 15 is an exploded perspective view of a built-in circuit board, a plurality of first conductive cables, a plurality of second conductive cables, a plurality of third conductive cables and a plurality of power cables in FIG. 13;

FIG. 16 is a perspective schematic view of the locking elastic piece in FIG. 11;

FIG. 17 is a perspective view of FIG. 16 from another angle;

FIG. 18 is a right side view of the locking elastic piece in FIG. 16;

FIG. 19 is a schematic cross-sectional view taken along line A-A in FIG. 1;

FIG. 20 is a schematic perspective view of the locking elastic piece of the electrical connector in accordance with another embodiment of the present disclosure;

FIG. 21 is a perspective view of FIG. 20 from another angle; and

FIG. 22 is a right side view of the locking elastic piece in FIG. 20.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

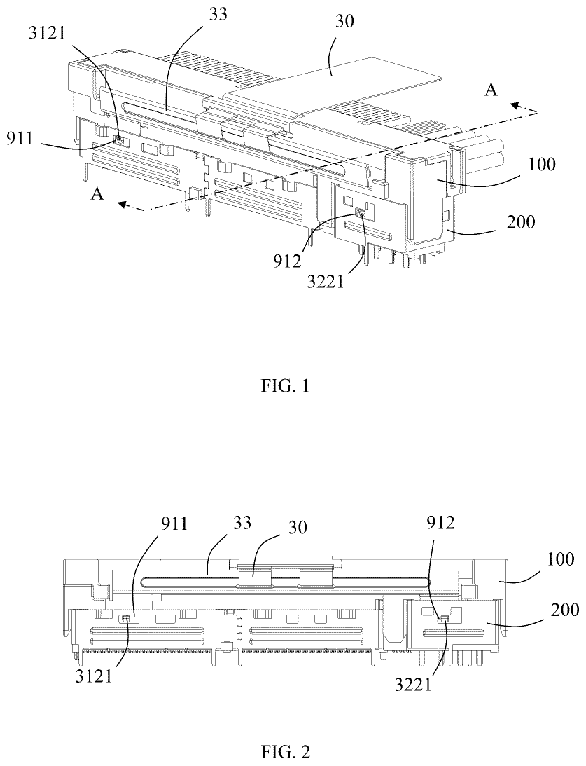

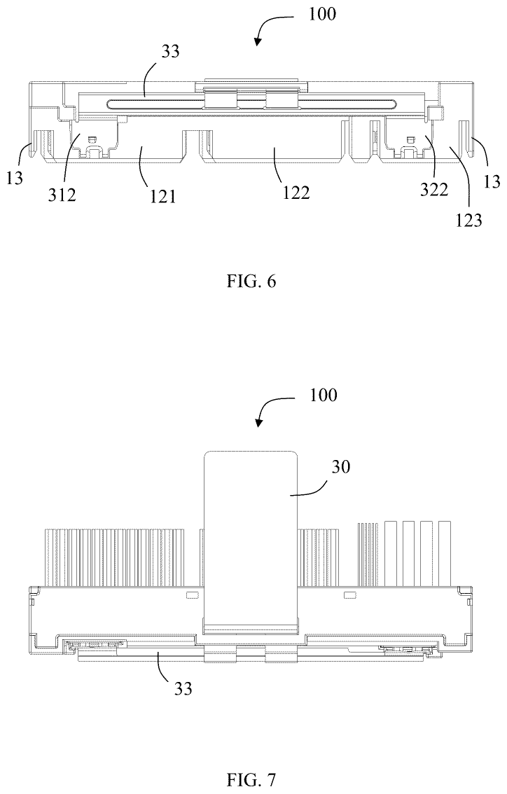

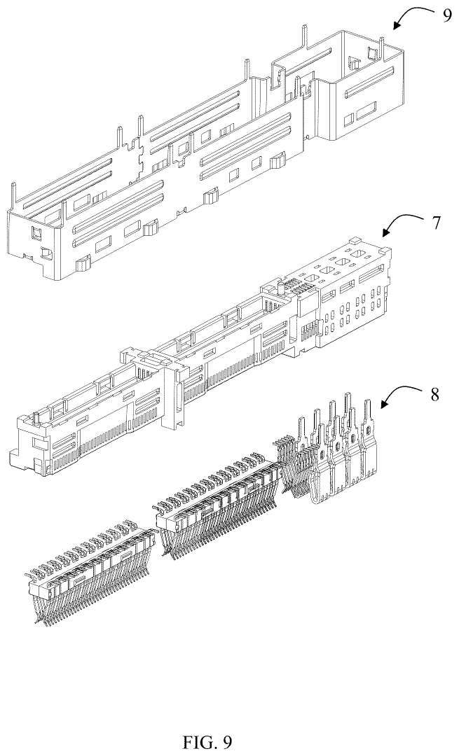

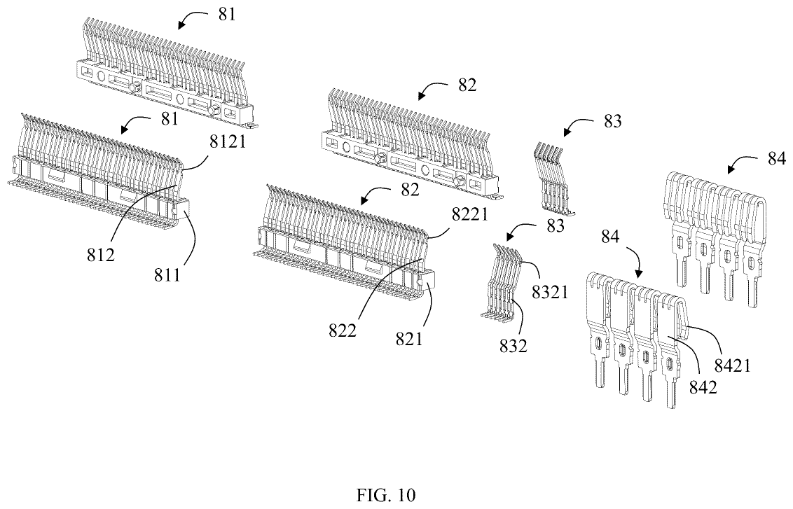

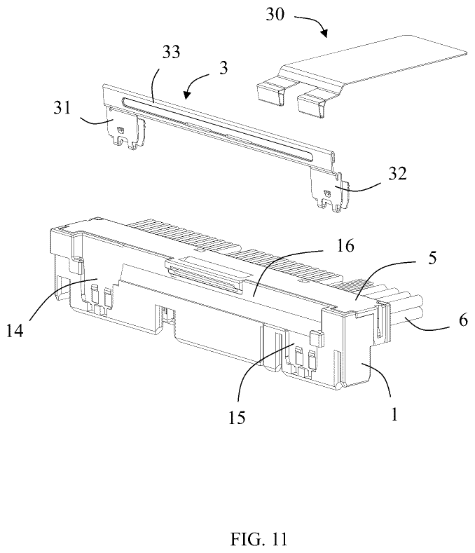

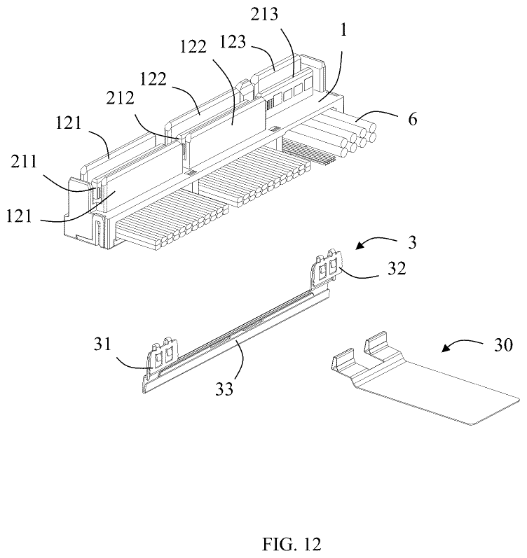

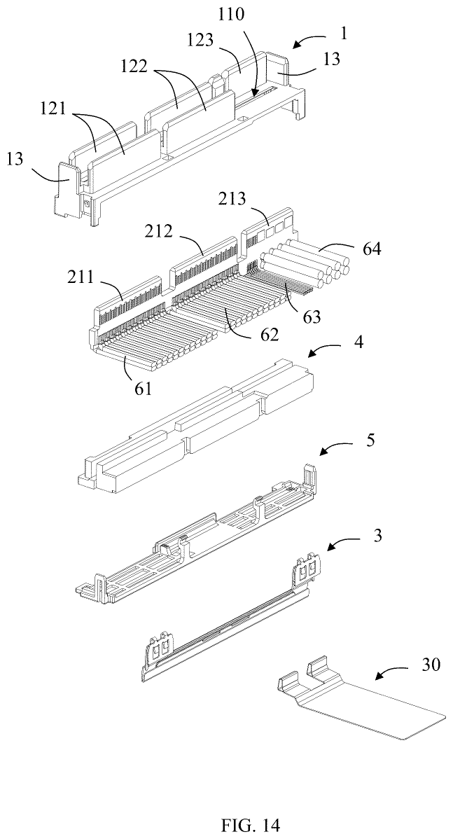

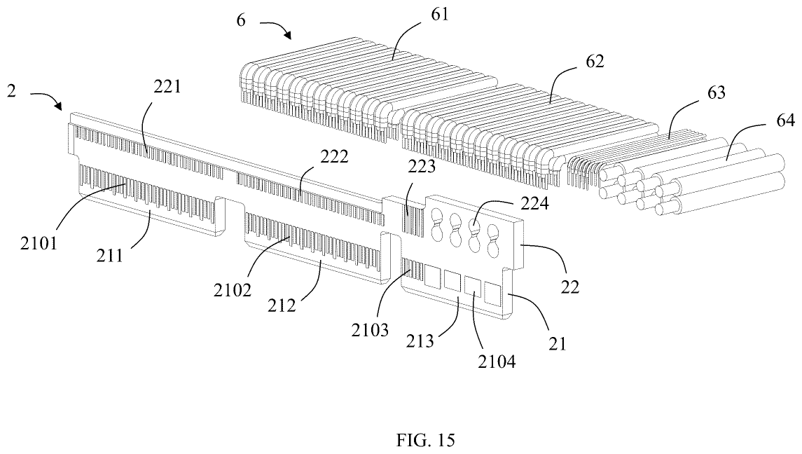

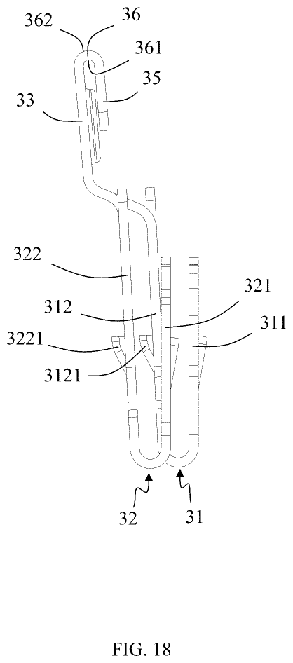

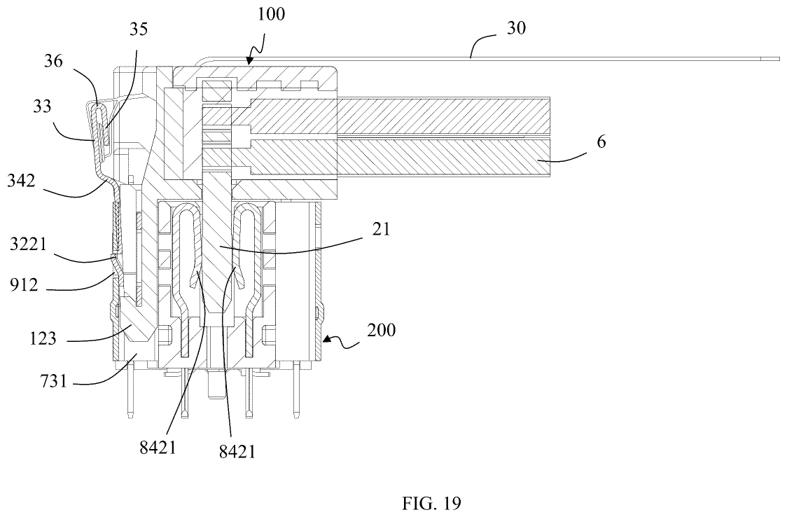

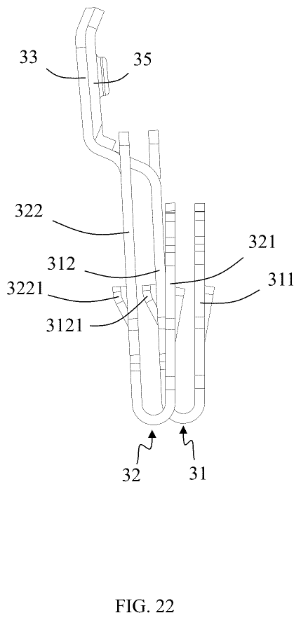

Referring to FIG. 1 to FIG. 22, the present disclosure discloses a connector assembly, which includes an electrical connector 100 and a mating connector 200 for mating with the electrical connector 100. In the illustrated embodiment of the present disclosure, the electrical connector 100 is a plug connector, and specifically a plug cable connector. The mating connector 200 is a receptacle connector, and specifically a board-end receptacle connector.

Referring to FIG. 1 to FIG. 5 and FIG. 8 to FIG. 10, in the illustrated embodiment of the present disclosure, the mating connector 200 includes a mating insulating body 7, a plurality of mating terminal modules 8 mounted to the mating insulating body 7, and an outer shell 9 covering the mating insulating body 7.

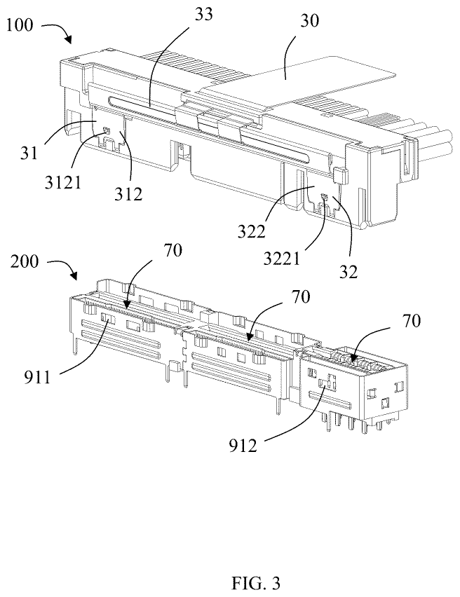

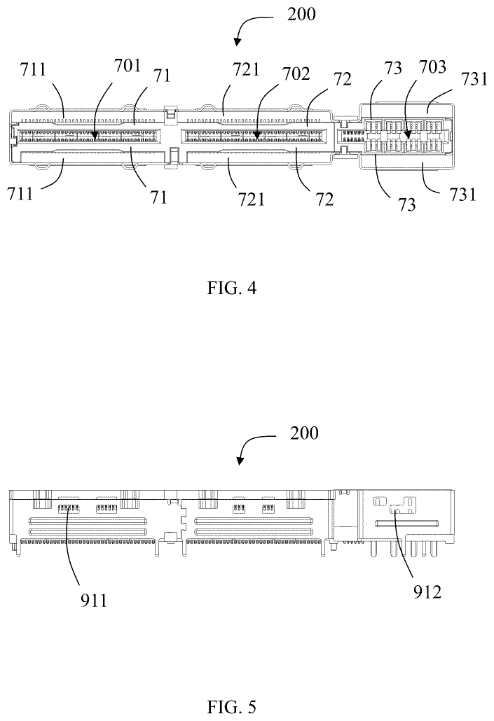

As shown in FIG. 3 and FIG. 4, the mating insulating body 7 includes a mating slot 70. In the illustrated embodiment of the present disclosure, the mating slot 70 includes a first mating slot 701, a second mating slot 702, a third mating slot 703 and a fourth mating slot 704. The first mating slot 701 and the second mating slot 702 are spaced apart from each other. The third mating slot 703 is in communication with the fourth mating slot 704.

The mating insulating body 7 includes two first side walls 71 located on two sides (for example, front and rear sides) of the first mating slot 701, two second side walls 72 located on two sides (for example, the front and rear sides) of the second mating slot 702, and two third side walls 73 located on two sides (for example, the front and rear sides) of the third mating slot 703 and the fourth mating slot 704. The mating insulating body 7 further defines two first positioning slots 711 located outside the first mating slot 701 and disposed on the two sides of the first mating slot 701, two second positioning slots 721 located outside the second mating slot 702 and disposed on the two sides of the second mating slot 702, and two third positioning slots 731 located outside the third mating slot 703 and the fourth mating slot 704, and disposed on the two sides of the third mating slot 703 and the fourth mating slot 704.

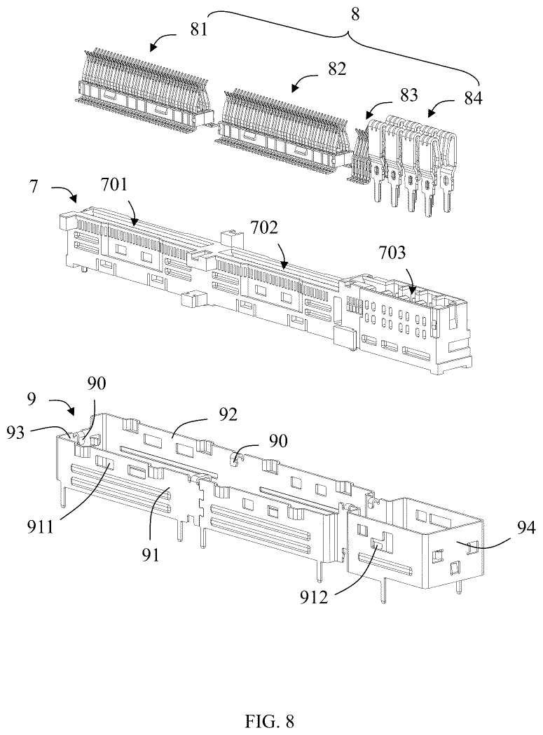

Referring to FIG. 8 to FIG. 10, in the illustrated embodiment of the present disclosure, the mating terminal module 8 includes a first mating terminal module 81, a second mating terminal module 82, a third mating terminal module 83 and a power terminal module 84.

In the illustrated embodiment of the present disclosure, two first mating terminal modules 81 are provided and they are symmetrically disposed on the two sides of the first mating slot 701. Each first mating terminal module 81 includes a first insulating block 811 and a plurality of first mating terminals 812 fixed to the first insulating block 811. In the illustrated embodiment of the present disclosure, the first mating terminals 812 are insert-molded with the first insulating block 811. Of course, in other embodiments of the present disclosure, the first mating terminals 812 may also be fixed to the first insulating block 811 through assembly. Each first mating terminal 812 includes a first mating elastic arm 8121 protruding into the first mating slot 701.

In the illustrated embodiment of the present disclosure, two second mating terminal modules 82 are provided and they are symmetrically disposed on the two sides of the second mating slot 702. Each second mating terminal module 82 includes a second insulating block 821 and a plurality of second mating terminals 822 fixed to the second insulating block 821. In the illustrated embodiment of the present disclosure, the second mating terminals 822 are insert-molded with the second insulating block 821. Of course, in other embodiments of the present disclosure, the second mating terminals 822 may also be fixed to the second insulating block 821 through assembly. Each second mating terminal 822 includes a second mating elastic arm 8221 protruding into the second mating slot 702.

In the illustrated embodiment of the present disclosure, two groups of third mating terminal modules 83 are provided and they are symmetrically disposed on the two sides of the third mating slot 703. Each third mating terminal module 83 includes a plurality of third mating terminals 832. In the illustrated embodiment of the present disclosure, each third mating terminal 832 includes a third mating elastic arm 8321 protruding into the third mating slot 703.

In the illustrated embodiment of the present disclosure, two groups of power terminal modules 84 are provided and they are symmetrically disposed on the two sides of the fourth mating slot 704. Each power terminal module 84 includes a plurality of fourth mating terminals 842. In the illustrated embodiment of the present disclosure, each fourth mating terminal 842 includes a fourth mating elastic arm 8421 protruding into the fourth mating slot 704.

In the illustrated embodiment of the present disclosure, the first mating terminals 812 and the second mating terminals 822 are signal terminals for transmitting signals. The fourth mating terminals 842 are power terminals for transmitting power. The third mating terminals 832 are signal terminals or power terminals. It is understandable to those skilled in the art that the types of the first mating terminals 812, the second mating terminals 822, the third mating terminals 832 and the fourth mating terminals 842 can be flexibly adjusted as needed, and will not be described in detail in the present disclosure.

Referring to FIG. 8, in the illustrated embodiment of the present disclosure, the outer shell 9 is made of metal material. The outer shell 9 encloses the mating insulating body 7. The outer shell 9 is provided with a plurality of retaining tabs 90 fixed to the mating insulating body 7. The outer shell 9 includes a first outer side wall 91, a second outer side wall 92 disposed opposite to the first outer side wall 91, a third outer side wall 93 connecting one end of the first outer side wall 91 and one end of the second outer side wall 92, and a fourth outer side wall 94 connecting another end of the first outer side wall 91 and another end of the second outer side wall 92. The first outer side wall 91 and the second outer side wall 92 are respectively located on two sides of the first positioning slot 711, respectively located on two sides of the second positioning slot 721, and respectively located on two sides of the third positioning slot 731.

In the illustrated embodiment of the present disclosure, the first outer side wall 91 defines a first locking hole 911 and a second locking hole 912. The first locking hole 911 and the second locking hole 912 both extend through the first outer side wall 91. The shapes of the first locking hole 911 and the second locking hole 912 can be flexibly adjusted as needed, and will not be described in detail in the present disclosure.

Referring to FIG. 1 to FIG. 3 and FIG. 11 to FIG. 19, in the illustrated embodiment of the present disclosure, the electrical connector 100 includes an insulating body 1, a built-in circuit board 2 fixed to the insulating body 1, a locking elastic piece 3 installed on the insulating body 1, an insulating over-molding block 4, a cover plate 5 fixed to the insulating body 1, a pull strap 30 connected to the locking elastic piece 3, and a plurality of cables 6 electrically connected to the built-in circuit board 2.

In the illustrated embodiment of the present disclosure, the insulating body 1 includes a base 11, a plurality of positioning plates 12 protruding beyond the base 11, and a plurality of positioning tabs 13 protruding beyond the base 11 and located on two sides of the base 11.

The base 11 defines a mounting slot 110 for installing the built-in circuit board 2. The insulating body 1 defines a first installation groove 14, a second installation groove 15, and a connecting groove 16 connecting the first installation groove 14 and the second installation groove 15. In the illustrated embodiment of the present disclosure, the first installation groove 14 and the second installation groove 15 both extend to the positioning plates 12. The insulating body 1 further includes a plurality of first protrusions 141 protruding into the first installation groove 14 and a first positioning block 142 protruding into the first installation groove 14. The insulating body 1 includes a plurality of second protrusions 151 protruding into the second installation groove 15 and a second positioning block 152 protruding into the second installation groove 15.

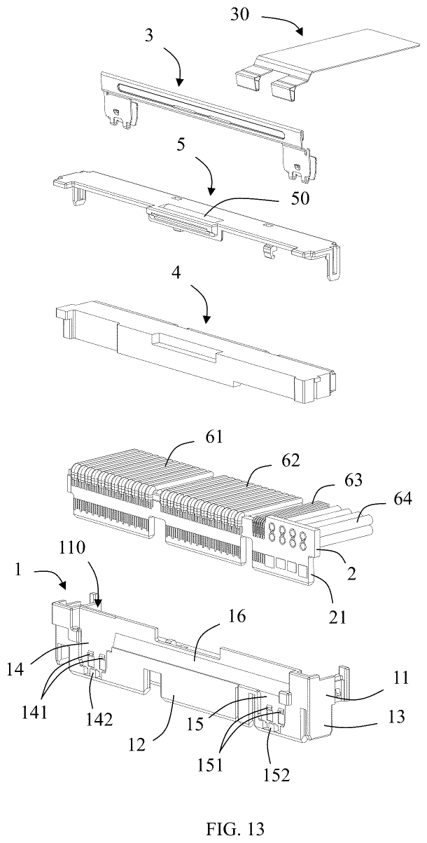

As shown in FIG. 13 to FIG. 15, the built-in circuit board 2 includes a tongue plate 21. A plurality of conductive pads 210 are respectively provided on two sides of the tongue plate 21. In the illustrated embodiment of the present disclosure, the tongue plate 21 includes a first tongue plate 211, a second tongue plate 212 and a third tongue plate 213. A plurality of first conductive pads 2101 are respectively provided on two sides of the first tongue plate 211. A plurality of second conductive pads 2102 are respectively provided on two sides of the second tongue plate 212. A plurality of third conductive pads 2103 and a plurality of power conductive pads 2104 are respectively provided on two sides of the third tongue plate 213. The conductive pads 210 include the first conductive pads 2101, the second conductive pads 2102, the third conductive pads 2103 and the power conductive pads 2104.

The first tongue plate 211 is configured to be inserted into the first mating slot 701 so that the first conductive pads 2101 are in contact with the first mating terminals 812. The second tongue plate 212 is configured to be inserted into the second mating slot 702 so that the second conductive pads 2102 are in contact with the second mating terminals 822. The third tongue plate 213 is configured to be inserted into the third mating slot 703 and the fourth mating slot 704, so that the third conductive pads 2103 and the power conductive pads 2104 are in contact with the third mating terminals 832 and the fourth mating terminals 842, respectively.

The built-in circuit board 2 includes a base plate 22 connected to the tongue plate 21. The base plate 22 is provided with a plurality of first welding pads 221 electrically connected to the first conductive pads 2101, a plurality of second welding pads 222 electrically connected to the second conductive pads 2102, a plurality of third welding pads 223 electrically connected to the third conductive pads 2103, and a plurality of conductive holes 224 electrically connected to the power conductive pads 2104.

The plurality of cables 6 include a plurality of first cables 61, a plurality of second cables 62, a plurality of third cables 63 and a plurality of power cables 64. The first cables 61 and the first welding pads 221 are fixed by soldering or welding. The second cables 62 and the second welding pads 222 are fixed by soldering or welding. The third cables 63 and the third welding pads 223 are fixed by soldering or welding. The power cables 64 are at least partially inserted into the conductive holes 224 and are electrically connected to the corresponding conductive holes 224. In an embodiment of the present disclosure, the power cables 64 and the conductive holes 224 are fixed by soldering or welding.

The insulating over-molding block 4 is over-molded at the joint between the built-in circuit board 2 and the cables 6 to increase the structural strength and reduce problems such as loosening of welds.

The positioning plates 12 include two first positioning plates 121 located on two sides of the first tongue plate 211, two second positioning plates 122 located on two sides of the second tongue plate 212, and a third positioning plate 123 located on one side of the third tongue plate 213. The first positioning plates 121 are configured to be inserted into the first positioning slots 711, the second positioning plates 122 are configured to be inserted into the second positioning slots 721, and the third positioning plate 123 is configured to be inserted into a corresponding third positioning slot 731, so that the mating reliability is improved.

The cover plate 5 is fixed to the insulating body 1. The cover plate 5 defines a pull strap hole 50 for the pull strap 30 to pass through.

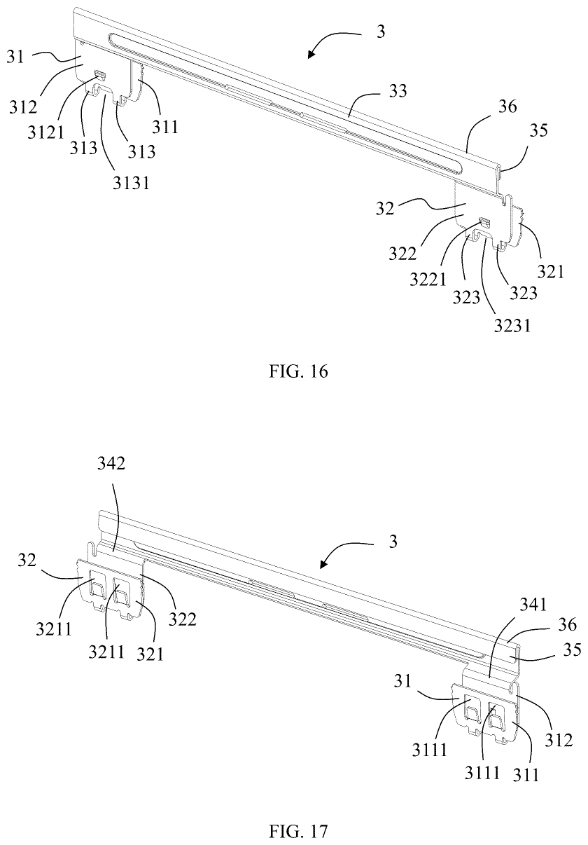

Referring to FIG. 16 to FIG. 18, in the illustrated embodiment of the present disclosure, the locking elastic piece 3 is made of metal material. The locking elastic piece 3 includes a first locking portion 31, a second locking portion 32, and a connecting wall 33 connecting the first locking portion 31 and the second locking portion 32. The first locking portion 31 is at least partially installed in the first installation groove 14. The second locking portion 32 is at least partially installed in the second installation groove 15. The connecting wall 33 is at least partially located in the connecting groove 16. The pull strap 30 is connected to the connecting wall 33.

Specifically, in the illustrated embodiment of the present disclosure, the first locking portion 31 is generally U-shaped and includes a first fixing piece 311, a first locking piece 312 spaced apart from the first fixing piece 311, and two first connecting pieces 313 connecting the first fixing piece 311 and the first locking piece 312. The first fixing piece 311 is fixed in the first installation groove 14. The first fixing piece 311 defines a plurality of first openings 3111 that are locked with the first protrusions 141. The first locking piece 312 includes a first locking protrusion 3121. The first locking piece 312 is configured to elastically deform in a direction closer to the first fixing piece 311 under an action of an external force. In the illustrated embodiment of the present disclosure, the first locking protrusion 3121 is integrally stamped from the first locking piece 312. The first locking portion 31 defines a first positioning notch 3131 located between the two first connecting pieces 313. The first positioning notch 3131 mates the first positioning block 142.

The second locking portion 32 is generally U-shaped and includes a second fixing piece 321, a second locking piece 322 spaced apart from the second fixing piece 321, and two second connecting pieces 323 connecting the second fixing piece 321 and the second locking piece 322. The second fixing piece 321 is fixed in the second installation groove 15. The second fixing piece 321 defines a plurality of second openings 3211 that are locked with the second protrusions 151. The second locking piece 322 includes a second locking protrusion 3221. The second locking piece 322 is configured to elastically deform in a direction closer to the second fixing piece 321 under the action of the external force. In the illustrated embodiment of the present disclosure, the second locking protrusion 3221 is integrally stamped from the second locking piece 322. The second locking portion 32 defines a second positioning notch 3231 located between the two second connecting pieces 323. The second positioning notch 3231 mates the second positioning block 152.

In the illustrated embodiment of the present disclosure, the first fixing piece 311 and the second fixing piece 321 are located in different planes; and/or the first locking piece 312 and the second locking piece 322 are located in different planes. With this arrangement, the first locking portion 31 and the second locking portion 32 can be individually designed according to their matching structures, and they do not have to be exactly the same.

In the illustrated embodiment of the present disclosure, the first locking piece 312 and the connecting wall 33 are located in different planes. The locking elastic piece 3 includes a first deflection portion 341 connecting the first locking piece 312 and the connecting wall 33. Similarly, the second locking piece 322 and the connecting wall 33 are located in different planes. The locking elastic piece 3 includes a second deflection portion 342 connecting the second locking piece 322 and the connecting wall 33. In other words, in the illustrated embodiment of the present disclosure, the first locking piece 312 and the connecting wall 33 are generally in a step-shaped configuration. The second locking piece 322 and the connecting wall 33 are generally in a step-shaped configuration.

The locking elastic piece 3 further includes a reinforcing wall 35 that at least partially overlaps the connecting wall 33 to increase the rigidity of the connecting wall 33. The connecting wall 33 and the reinforcing wall 35 form a double-layer structure.

Referring to FIG. 16 to FIG. 18, in one embodiment of the present disclosure, the connecting wall 33 and the reinforcing wall 35 are of an integral structure. The locking elastic piece 3 further includes a bent portion 36 connecting the connecting wall 33 and the reinforcing wall 35. The bent portion 36 has an arc-shaped inner surface 361 and an arc-shaped outer surface 362. Before the external force acts on the locking elastic piece 3, the connecting wall 33 and the reinforcing wall 35 are in contract with each other or spaced apart from each other. By providing the bent portion 36, it is advantageous for the connecting wall 33 itself to be less likely to deform when the connecting wall 33 is subjected to the external force. In the illustrated embodiment of the present disclosure, the force of the locking elastic piece 3 pulls the pull strap 30 through the external force. Of course, in other embodiments, the external force can also be directly applied to the locking elastic piece 3, which will not be described in detail in the present disclosure.

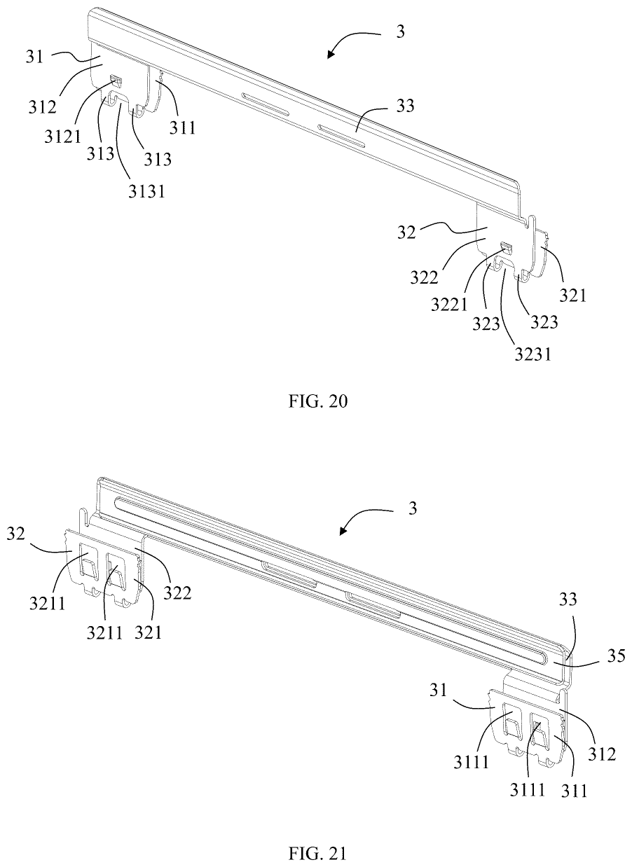

As shown in FIG. 20 to FIG. 22, in another embodiment of the present disclosure, the connecting wall 33 and the reinforcing wall 35 are two components. The reinforcing wall 35 abuts against the connecting wall 33 and is fixed with the connecting wall 33. In another embodiment of the present disclosure, the connecting wall 33 is U-shaped, and the reinforcing wall 35 is also U-shaped. The shape and size of the reinforcing wall 35 are adapted to the shape and size of the connecting wall 33. An outer surface of the reinforcing wall 35 is closely abutted against an inner surface of the connecting wall 33. In the illustrated embodiment of the present disclosure, the force of the locking elastic piece 3 pulls the pull strap 30 through the external force. Of course, in other embodiments, the external force can also be directly applied to the locking elastic piece 3, which will not be described in detail in the present disclosure.

When the electrical connector 100 is mated with the mating connector 200, the first locking protrusion 3121 and the second locking protrusion 3221 of the electrical connector 100 are locked in the first locking hole 911 and the second locking hole 912 of the mating connector 200, respectively, so as to prevent the electrical connector 100 and the mating connector 200 from loosening or detaching due to an improper external force.

When unlocking is required, the external force acts on the pull strap 30 (for example, pulling the pull strap 30 backwardly). The present disclosure increases the structural strength of the connecting wall 33 by providing the reinforcing wall 35, so that when the pull strap 30 is pulled by the external force, the connecting wall 33 fastened with the pull strap 30 has good rigidity and is not prone to elastic deformation. At this time, the external force is more likely to drive the first locking piece 312 and the second locking piece 322 to elastically deform through the connecting wall 33, causing the first locking protrusion 3121 and the second locking protrusion 3221 to be separated from the first locking hole 911 and the second locking hole 912 of the mating connector 200 to achieve unlocking.

Since the connecting wall 33 is connected between the first locking portion 31 and the second locking portion 32, the connecting wall 33 is shaped like a moment arm cantilever beam. The moment arm cantilever beam is prone to elastic deformation when it is pressed, so that the external force cannot be well transmitted to the first locking piece 312 and the second locking piece 322, which further affects the deformation of the first locking protrusion 3121 and the second locking protrusion 3221. In the illustrated embodiment of the present disclosure, by providing the reinforcing wall 35, the structural strength of the connecting wall 33 is increased and the risk of elastic deformation of the connecting wall 33 is reduced. As a result, the present invention improves the reliability of the connecting wall 33 in driving the first locking portion 31 and the second locking portion 32 to elastically deform, thereby improving the unlocking reliability when the electrical connector 100 and the mating connector 200 need to be separated from each other.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
an insulating body, the insulating body defining a first installation groove and a second installation groove;
a tongue plate, the tongue plate being fixed to the insulating body, the tongue plate comprising a plurality of conductive pads provided on at least one surface thereof; and
a locking elastic piece, the locking elastic piece comprising a first lock portion, a second lock portion and a connecting wall connecting the first locking portion and the second locking portion; the first locking portion being at least partially installed in the first installation groove; the second locking portion being at least partially installed in the second installation groove; the first locking portion comprising a first locking protrusion; the second locking portion comprising a second locking protrusion; the first locking protrusion and the second locking protrusion being configured to mate with a first locking hole and a second locking hole of a mating connector, respectively; the connecting wall being configured to drive the first locking portion and the second locking portion to elastically deform under an action of an external force, so that the first locking protrusion and the second locking protrusion are separated from the first locking hole and the second locking hole of the mating connector;
wherein the locking elastic piece further comprises a reinforcing wall that at least partially overlaps the connecting wall to increase rigidity of the connecting wall; the connecting wall and the reinforcing wall form a double-layer structure.

2. The electrical connector according to claim 1, wherein the connecting wall and the reinforcing wall are of an integrated structure; the locking elastic piece further comprises a bent portion connecting the connecting wall and the reinforcing wall.

3. The electrical connector according to claim 2, wherein the bent portion has an arc-shaped inner surface and an arc-shaped outer surface;
before the external force acts on the locking elastic piece, the connecting wall and the reinforcing wall are in contact with each other or spaced apart from each other.

4. The electrical connector according to claim 1, wherein the connecting wall and the reinforcing wall are two components; the reinforcing wall is in contact with the connecting wall and is fixed with the connecting wall.

5. The electrical connector according to claim 4, wherein the connecting wall is U-shaped, and the reinforcing wall is also U-shaped; an outer side of the reinforcing wall is closely abutted against an inner side of the connecting wall.

6. The electrical connector according to claim 1, wherein the first locking portion is U-shaped and comprises a first fixing piece, a first locking piece spaced apart from the first fixing piece, and a first connecting piece connecting the first fixing piece and the first locking piece; the first fixing piece is fixed in the first installation groove; the first locking protrusion is provided on the first locking piece; the first locking piece is configured to be elastically deformable in a direction closer to the first fixing piece under the action of the external force;
the second locking portion is U-shaped and comprises a second fixing piece, a second locking piece spaced apart from the second fixing piece, and a second connecting piece connecting the second fixing piece and the second locking piece; the second fixing piece is fixed in the second installation groove; the second locking protrusion is provided on the second locking piece; the second locking piece is configured to be elastically deformable in a direction closer to the second fixing piece under the action of the external force.

7. The electrical connector according to claim 6, wherein the first locking piece and the connecting wall are located in different planes; the locking elastic piece comprises a first deflection portion connecting the first locking piece and the connecting wall;
the second locking piece and the connecting wall are located in different planes; the locking elastic piece comprises a second deflection portion connecting the second locking piece and the connecting wall.

8. The electrical connector according to claim 6, wherein the first locking protrusion is integrally stamped from the first locking piece, and the second lock protrusion is integrally stamped from the second lock piece.

9. The electrical connector according to claim 6, wherein the first fixing piece and the second fixing piece are located in different planes; and/or
the first locking piece and the second locking piece are located in different planes.

10. The electrical connector according to claim 1, further comprising a pull strap connected to the connecting wall.

11. The electrical connector according to claim 1, further comprising a built-in circuit board on which the tongue plate is provided; the plurality of conductive pads comprise a power conductive pad; the built-in circuit board defines a conductive hole electrically connected with the power conductive pad;
the electrical connector further comprises a power cable at least partially inserted into the conductive hole and electrically connected with the power conductive pad.

12. The electrical connector according to claim 1, wherein the insulating body comprises a positioning plate located on at least one side of the tongue plate; and the positioning plate is configured to be inserted into a positioning slot of the mating connector.

13. A connector assembly, comprising:
an electrical connector, the electrical connector comprising:
an insulating body, the insulating body defining a first installation groove and a second installation groove;
a tongue plate, the tongue plate being fixed to the insulating body, the tongue plate comprising a plurality of conductive pads provided on at least one surface thereof; and
a locking elastic piece, the locking elastic piece comprising a first lock portion, a second lock portion and a connecting wall connecting the first locking portion and the second locking portion; the first locking portion being at least partially fixed in the first installation groove; the second locking portion being at least partially fixed in the second installation groove; the first locking portion comprising a first locking protrusion; the second locking portion comprising a second locking protrusion;
wherein the locking elastic piece further comprises a reinforcing wall that at least partially overlaps the connecting wall to increase rigidity of the connecting wall; the connecting wall and the reinforcing wall form a double-layer structure; and
a mating connector, the mating connector comprising a mating insulating body, a plurality of mating conductive terminals mounted to the mating insulating body, and an outer shell fixed to the mating insulating body; the mating insulating body comprising a mating slot; the outer shell defining a first locking hole and a second locking hole;
when the electrical connector is mated with the mating connector, the tongue plate is at least partially inserted into the mating slot; the conductive pads on the tongue plate are in contact with the mating conductive terminals; the first locking protrusion and the second locking protrusion of the electrical connector are locked in the first locking hole and the second locking hole of the mating connector, respectively;
when unlocking is required, the connecting wall drives the first lock portion and the second lock portion to elastically deform under an action of an external force, so that the first locking protrusion and the second locking protrusion are separated from the first locking hole and the second locking hole of the mating connector.

14. The connector assembly according to claim 13, wherein the connecting wall and the reinforcing wall are of an integrated structure; the locking elastic piece further comprises a bent portion connecting the connecting wall and the reinforcing wall.

15. The connector assembly according to claim 14, wherein the bent portion has an arc-shaped inner surface and an arc-shaped outer surface;
before the external force acts on the locking elastic piece, the connecting wall and the reinforcing wall are in contact with each other or spaced apart from each other.

16. The connector assembly according to claim 13, wherein the connecting wall and the reinforcing wall are two components; the reinforcing wall is in contact with the connecting wall and is fixed with the connecting wall.

17. The connector assembly according to claim 16, wherein the connecting wall is U-shaped, and the reinforcing wall is also U-shaped; an outer side of the reinforcing wall is closely abutted against an inner side of the connecting wall.

18. The connector assembly according to claim 13, wherein the first locking portion is U-shaped and comprises a first fixing piece, a first locking piece spaced apart from the first fixing piece, and a first connecting piece connecting the first fixing piece and the first locking piece; the first fixing piece is fixed in the first installation groove; the first locking protrusion is provided on the first locking piece; the first locking piece is configured to be elastically deformable in a direction closer to the first fixing piece under the action of the external force;
the second locking portion is U-shaped and comprises a second fixing piece, a second locking piece spaced apart from the second fixing piece, and a second connecting piece connecting the second fixing piece and the second locking piece; the second fixing piece is fixed in the second installation groove; the second locking protrusion is provided on the second locking piece; the second locking piece is configured to be elastically deformable in a direction closer to the second fixing piece under the action of the external force.

19. The connector assembly according to claim 18, wherein the first locking piece and the connecting wall are located in different planes; the locking elastic piece comprises a first deflection portion connecting the first locking piece and the connecting wall;
the second locking piece and the connecting wall are located in different planes; the locking elastic piece comprises a second deflection portion connecting the second locking piece and the connecting wall.

20. The connector assembly according to claim 18, wherein the first locking protrusion is integrally stamped from the first locking piece, and the second lock protrusion is integrally stamped from the second lock piece; and
wherein the first fixing piece and the second fixing piece are located in different planes; and/or the first locking piece and the second locking piece are located in different planes.
